(19) United States
(12) Patent Application Publication
(10) Pub. No.: US 2020/0231457 A1
(43) Pub. Date: Jul. 23, 2020

(54) Reduced carbon ammonia generation process

(71) Applicant: Kenneth Miles Hanson, Oaksdale, WA (US)

(72) Inventor: Kenneth Miles Hanson, Oaksdale, WA (US)

(21) Appl. No.: 16/746,798

(22) Filed: Jan. 17, 2020

Related U.S. Application Data
(60) Provisional application No. 62/793,809, filed on Jan. 17, 2019.

(51) Int. Cl. C01C 1/04

(52) U.S. Cl. CPC C01C 1/0488; C01C 1/0476; C01C 1/0452

(57) ABSTRACT

A method of generating ammonia while minimizing the generation of carbon dioxide. The method uses the waste of other processes as inputs to the chemical process. It also uses the energy of other processes to catalyze the process.

### CROSS-REFERENCE TO RELATED APPLICATIONS

This application claims priority to provisional application 62/793,809 filed on Jan. 17, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

Ammonia is an inorganic chemical with a wide variety of applications. Ammonia is naturally occurring in certain environments. Ammonia is one part hydrogen, and three parts nitrogen (NH₃). Nitrogen is very abundant in gas form since dry air is approximately 78% nitrogen. Hydrogen (a component element of water) is also plentiful. Although there are a variety of hydrogen sources available, hydrogen extracted from methane extracted from natural gas through a process known as steam reforming is a common source for chemical applications due to the efficiency of the process of steam reforming. Due to its many uses, ammonia is one of the most highly produced chemicals.

Modern ammonia is primarily produced using a method referred to as the Haber-Bosch process whereby atmospheric nitrogen is combined with industrial hydrogen under high pressure (approximately 150-200 atmospheres) and high temperature (approximately 400-500° C.) in the presence of an iron catalyst. This iron catalyst is often promoted with K₂O, CaO, SiO₂, and Al₂O₃ to speed the reaction. As the process produces ammonia, the process slows. Therefore, the mixture is allowed to react in a reaction chamber for an amount of time. The reaction vessel contents are then removed from the vessel. The desired ammonia is separated from un-reacted hydrogen and nitrogen. The un-reacted hydrogen and nitrogen are fed back into the reaction vessel and the ammonia is removed from the process. More than 1% of the world's man-made power is consumed producing ammonia. In 2014, global ammonia production was estimated to be 176 million tonnes. Approximately 88% of global ammonia is used to fertilize agricultural crops.

Many agricultural users have ammonia storage tanks (nurse tanks) to hold anhydrous ammonia from the time when it is delivered until they apply the ammonia to their fields. These tanks are fairly expensive because they must withstand significant pressure. At 100° F., anhydrous ammonia may exert 200 psi on a tank in which it is contained. The occasional use of the vessels, combined with the high cost of the tank may lead to poor capital utilization. The vapor pressure of ammonia is proportional to the temperature of the ammonia requiring either fairly strong tanks, constant refrigeration, or a combination of the two. The vapor pressure of ammonia at various temperatures is at follows: −28° F.—0 psi, 0° F.—16 psi, 32° F.—48 psi, 60° F.—93 psi, 100° F.—200 psi.

One of the most cost-efficient methods to concentrate gasses is through a process called pressure swing absorption (PSA). PSA utilizes the fact that under high pressure, gasses tend to be attracted to, or “absorbed” by, solid surfaces. Higher pressures result in more gas being absorbed. When the pressure is reduced, the gas is released by the solid surfaces. Although only a very thin layer of the surface of the solid absorbs gas, porous materials, in volume, can have very large cumulative surface areas. Certain materials absorb more of one gas than another. For example, zeolite attracts nitrogen more strongly than oxygen and is useful for producing either oxygen enriched air (through absorption) or nitrogen enriched air (through desorption). PSA may be used to concentrate a variety of gasses based on the absorbent selected since certain absorbents have a greater affinity for certain gases and/or the molecular size of certain absorbents permissibly pass certain gases essentially filtering out others. An industrial nitrogen generator PSA is capable of producing about 9000 Nm³/h of nitrogen at 97% purity.

Co-generation (sometimes referred to as combined heat and power, CHP) is the process of using an engine for a useful purpose and a bi-product (such as heat) of the engine for some additional useful purpose. A common example of co-generation is an automobile where the heat of the internal combustion engine (used to propel and power the vehicle) may be diverted into the cabin of the automobile to heat the air (for greater passenger comfort). Poly-generation is a general term for using additional forms of energy from an engine process for additional useful purposes. One of the more common forms of poly-generation is combined cooling, heat, and power (CCHP) which refers to the simultaneous generation of electricity and useful heating and cooling from the combustion of a fuel.

Natural gas distribution networks are generally comprised of liquefied and gaseous transportation segments. Liquefied segments are often used to transport between continents or along other segments where it is less feasible (geographically or politically) to build pipelines. Gaseous transportation segments generally consist of a network of pipelines which distribute natural gas from one or more sources to numerous end-users. Although consumption of natural gas may be less seasonal than it used to be, demand fluctuates significantly. End-users could be faced with very low pressure if a transmission and distribution network was pressurized only at the source since natural gas may be consumed at various points along the network. Therefore, distribution networks of significant size generally locate compressor stations throughout the network, approximately every 65-160 km on transmission segments, to increase pressure and keep the gas flowing at approximately 40 km per hour to compensate for gas consumed nearer the source.

Compressor stations are generally comprised of an engine at a point along a transmission segment of a natural gas transmission and distribution network. Natural gas is diverted from the transmission line into the station infrastructure. The gas is filtered and/or scrubbed to remove liquids, solids, and other particulate matter from the incoming natural gas. A portion of the incoming natural gas may also be diverted to power the compressor. The remainder of the incoming natural gas is then directed into the compressor. The compressor is most often either a turbine with a centrifugal compressor, an electric motor with a centrifugal compressor, or a reciprocating engine with a reciprocating compressor. In the case of the turbine and the reciprocating engine, natural gas from the transmission line is frequently used to power the compressor. As the gas is compressed, the temperature of the gas increases as basic chemical and physical principles dictate according to the ideal gas law (P V=n R T). The compressed gas is then often directed into a gas cooling system to reduce the temperature of the gas to a temperature where it will not pose a risk to the transmission system. The cooled gas is then directed back into the transmission system at elevated pressure.

Turbochargers and superchargers both offer ways to compress gasses. A supercharger is directly connected to an engine. It takes mechanical energy produced by an engine (off a crank shaft or drive shaft) to compress air which is fed into the engine to improve the power of that engine. A turbocharger may not be directly mechanically connected to an engine. Rather, a turbocharger takes energy from the exhaust flow of an engine to compress air which is fed into the engine to improve the power of that engine. In motor vehicle applications, turbochargers have some disadvantages compared to superchargers. Turbochargers run hot due to their placement in the exhaust flow and there is a delay between request for power (pressing on the gas pedal) and power delivery.

The Rankine cycle describes the idealized process of generating dynamic energy from thermal energy. It is a closed-loop process where a liquid is heated in a boiler and converted into steam, thereby creating pressure. The pressure drives a turbine. The steam is then cooled and converted back into a liquid in a condenser. The cooled liquid is then pumped into the boiler to begin the cycle again. The maximum theoretical efficiency of the Rankine cycle is about 63% with modern coal-fired steam turbine power stations achieving up to 42% efficiency. The amount of power generated depends on the difference between the high and low temperatures which often depend on the temperature of an available fluid to use as a cooling agent. A common operating ranges for a steam turbine is approximately 565° C. at the entry to the steam turbine and approximately 30° C. at the exit of the condenser.

Certain bacteria are able to feed on gasses, particularly hydrogen, carbon monoxide, carbon dioxide, and methane. Processes, such as those popularized by LanzaTech are well known in the art. Clostridium autoethanogenum is one such anaerobic bacterium which produces ethanol from carbon dioxide. In a conventional process, a carbon gas stream from an industrial source (such as steel manufacturing), biogas (such as from agricultural animal facilities), gassification from a solid waste stream, or biomass (such as accumulated agriculture materials like straw) is accumulated, compressed, and directed into a fermentation chamber. In the fermentation chamber, bacteria feed on the carbon-rich gas and excrete ethanol as waste. The waste is fed into a recovery vessel where the desired product, such as ethanol, is concentrated. The concentrated output is then fed into, and stored in, a product tank.

Concern regarding climate change is driving technological innovation. Many people believe increasing amounts of so-called “greenhouse gases,” including carbon dioxide (CO₂) and nitrogenous gasses, in the atmosphere is causing global temperatures to rise, sea levels to rise, and adverse weather events to occur with greater frequency and severity. For that reason, processes which reduce or eliminate the production of these “greenhouse gasses” are highly desirable. The amount of heat various “greenhouse gasses” can trap varies, but nitrogenous gasses, such as nitrous oxide, may trap nearly 300 times as much heat as carbon dioxide.

### DESCRIPTION OF RELATED ART INCLUDING INFORMATION DISCLOSED UNDER 37 CFR 1.97 AND 37 CFR 1.98

Not Applicable

### BRIEF SUMMARY OF THE INVENTION

An improved process for reducing the creation and release of greenhouse gasses in manufacturing ammonia through a poly-generation process using outputs from a gas pipeline compressor, or other waste heat, to power and accelerate the Haber-Bosch process.

### BRIEF DESCRIPTION OF THE SEVERAL VIEWS OF THE DRAWING

FIG. 1 depicts the conventional Haber-Bosch process of manufacturing ammonia.

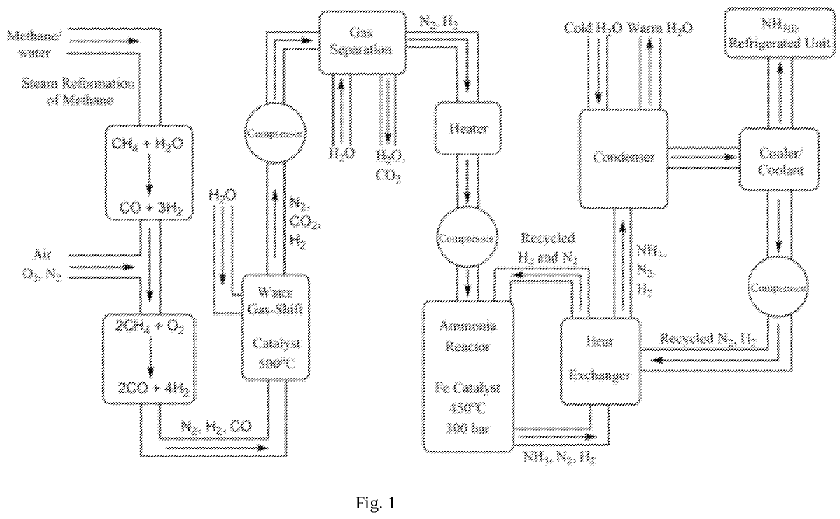

FIG. 2 depicts a conventional natural gas pipeline compressor station.

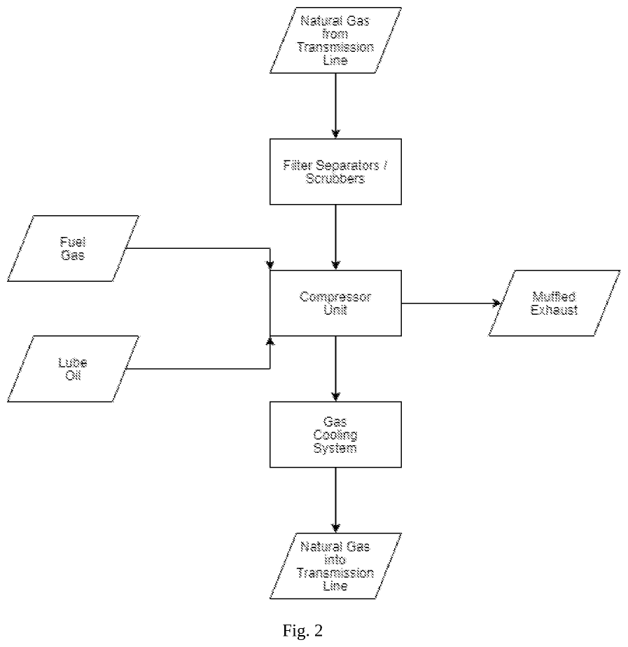

FIG. 3 depicts one embodiment of the applicant's improved process.

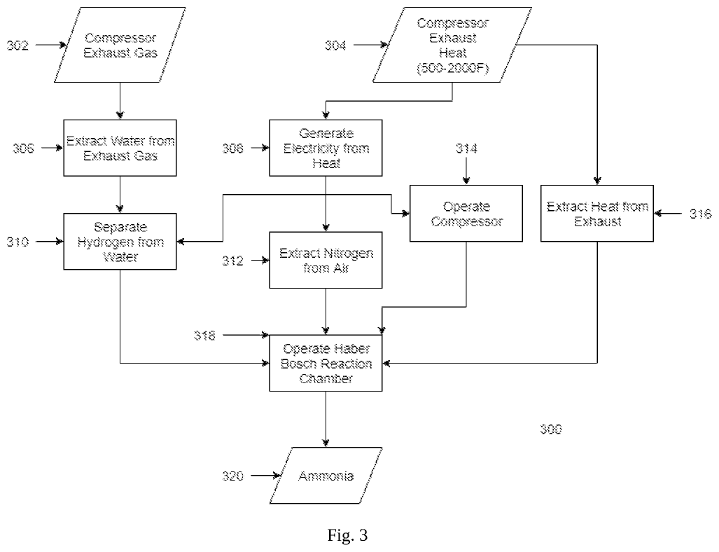

### DETAILED DESCRIPTION OF THE INVENTION

The applicant's invention is an improved poly-generation process preferably using gas turbine engines. In a preferred embodiment, the co-generation process 300 is used to manufacture ammonia. The process centers around harnessing the energy, and waste energy, from gas turbine (or internal combustion) compressor stations along natural gas transmission pipelines to generate ammonia through the Haber-Bosch process. Gas pipeline compressor stations are geographically dispersed throughout the country. Many are located away from urban centers, in or near agricultural areas. Although compressor stations are not particularly loud and do not generally have toxic emissions, the need to locate them at intervals along transmission lines naturally results in them being geographically dispersed. Natural gas fueled compressors are particularly desirable for gas pipeline compressor stations since the pipeline which the compressor station serves carries fuel for the compressor thereby reducing the infrastructure required to power the compressor station. Although natural gas powered gas turbine compressors are made by a variety of companies with a variety of specifications, one example gas turbine used for compressor station applications is a Siemens SGT-700. The Siemens SGT-700 is rated for a compression ratio of 18.7:1, has an exhaust gas flow of 95.0 kg/s (209.41 b/s), has an exhaust temperature: 533° C. (991° F.), and is rated to be approximately 38% efficient (depending on whether it is used to generate electricity or mechanical energy).

The chemical inputs to the Haber-Bosch process are generally methane, water, air, hydrogen, and nitrogen. Depending on the exact process used, inputs for subsequent stages may be derived from other precursor inputs (e.g. hydrogen from methane) or may be discrete inputs. The energy inputs to the Haber-Bosch process are temperature and pressure. The Haber-Bosch process is generally performed at a temperature of approximately 400-500° C. The water/gas shift step to remove water from methane also generally requires a temperature of approximately 500° C. Underutilized, or un-utilized, outputs of a conventional gas turbine compressor station include: heat 304 which is exchanged into the atmosphere, water vapor which is vented into the atmosphere, nitrogenous gasses 302 which are vented into the atmosphere, and kinetic energy (exhaust pressure) which is not captured.

The applicant's process may consume chemicals being pressurized (consumptively), or may operate only as a poly-generation process. When operating as a non-consumptive poly-generation process, energy generated in the process may be used to generate hydrogen through electrolysis of water 310 or pyrolysis of organic matter or suitable inorganic matter to produce hydrogen. This hydrogen may be used as a chemical input to the Haber-Bosch process 318, burned to release energy, or for any other beneficial operation in the process.

In an alternative process, hydrogen is generated from a sufficiently homogeneous material around which a hydrogen extraction processes may be optimized. Exemplary materials include biomasses including, but not limited to, wood fibers such as wood chips and sawdust, fibrous agricultural residuals such as straw, human and/or animal fecal biomass. Other exemplary materials include waste or recycled materials, such as plastics, which may be manually collected or otherwise harvested when they occur in sufficiently high quantities (such as cleaned from waterways or oceans).

A variety of pyrolysis processes are well known in the art including, but not limited to, microwave pyrolysis, and are suited to the applicant's novel process. Microwave pyrolysis is particularly well adapted to aspects of the applicant's process as microwave pyrolysis reactions often occur at temperatures which favor the production of gases rather than liquids. Microwave pyrolysis is well known to be suited to extracting energy from tires, plastics, and biomasses.

In the applicant's process, the heat removed from the gas in the gas cooling system and/or exhaust 304 of the compressor station is that heat 316 transmitted into the hydrogen and nitrogen being fed into the ammonia reactor 318 and/or the water/gas shift chamber. This heat transfer may be through any of a variety of heat exchange devices and processes which are well known in the art and may be direct or indirect. In a preferred embodiment, the heat exchanger is a radial flow gas/gas heat exchanger. This use of exhaust temperature to generate electricity 308 and heat to heat other processes 316 is the first use of waste energy from the compressor station (co-generation). Electricity generated from exhaust heat may be used to extract nitrogen from air 312 and/or power a compressor 314 to pressurize the Haber Bosch reaction chamber 318. In an alternative embodiment, heat from the exhaust is exchanged into either or both of the hydrogen and nitrogen being fed into the ammonia reactor 318 and/or the Water/Gas shift chamber. In an alternative embodiment additional heat may be added to the system from an additional source. In this alternative embodiment, the heat may be collected through heat transfer solar. In an agricultural, or agricultural adjacent location these heat transfer solar collectors may be installed on the corners of pivots (land not reached by center pivot irrigation systems).

In an alternative embodiment of the applicant's process, the exhaust flow from the gas turbine powers a turbocharger. However, rather than compressing gas which is input into the engine to which the turbocharger is attached, the turbocharger may be used to compress hydrogen and nitrogen which is being fed into the ammonia reactor. The turbo charger may alternatively be used to pressurize a PSA process for concentrating nitrogen from air. The turbocharger may alternatively be used to pressurize gas at the input stage of the ammonia pressure vessel. This use of exhaust flow is the second use of waste energy from the compressor station (poly-generation).

In the applicant's process, the ammonia generated through the Haber-Bosch process 320 is stored in existing nurse tanks which are already located in the area for agricultural use. In an alternative embodiment, one or more Low Pressure Storage Tanks (LPSTs) may be constructed or used to store the ammonia created through the Haber-Bosch process. When LPSTs are used, electricity generated from the improved process, or electrical power from another source, such as the electrical grid, may be used to refrigerate the LPST.

In the applicant's process the chemicals in the compressor exhaust are further used as an input to a downstream process. In one preferred embodiment, water vapor is removed from compressor exhaust 306. In a preferred embodiment, carbon-rich exhaust gasses are fed into a gas fermentation system where specific microbes generate ethanol (C₂H₅OH) from the exhaust gas thereby reducing the amount of greenhouse gasses released into the atmosphere from the compressor. In an alternative embodiment, the carbon rich gasses are generated by organic material (biomass) such as animal excrement or straw.

This ethanol may be used for a variety of applications. The ethanol may be sold on the open market, may be fed back into the system (to generate heat), may be used as a storage medium for precursor chemicals (particularly hydrogen) which is then separated from the ethanol for use in the process, or may be consumed locally (to power an internal combustion engine).

In another embodiment, the co-generation process is used to generate electricity 308. The majority of energy input into power generation through the Rankine cycle is to heat the liquid. Water is the most frequently used liquid since it is non-toxic, plentiful, and inexpensive. However, other liquids may be used for different temperature operating ranges. The non-idealized Rankine cycle (real power-plant cycle), when performed with water, generally operates with steam heated to approximately 400-500° C. Therefore, it is well suited to operation with the exhaust of a gas turbine engine (alternatively an organic Rankine cycle is used).

In the present process, heat from the exhaust of the gas turbine engine is transmitted into water/water vapor to power a steam engine generating electricity. This heat transfer may be through any of a variety of heat exchange devices and processes which are well known in the art and may be direct or indirect. In an alternative embodiment, heat removed from the gas in the gas cooling system of the compressor station is transmitted into water/water vapor to power a steam engine generating electricity. In a preferred embodiment, water being used for agricultural irrigation is used to chill the condenser of the steam engine providing a cool cold source providing a high temperature differential between the steam turbine entry temperature and the steam condenser temperature.

Control System

In a preferred embodiment of the applicant's invention, an electronic automatic control system is employed to manage which energy sources are used for which purpose(s). Inputs to the control system include, but are not limited to, the water requirements of various agricultural consumers (plant and/or animal), the present and/or predicted future prices of process products including water, hydrogen, nitrogen, methane and/or natural gas, ammonia, ethanol, plant and/or animal crops, and/or electricity. The control system is configured to take into account the various input and output prices and determine which sub-processes to operate based on whether and which are most profitable.

Pressure created/captured from the system is useful when creating ammonia to 1) compress gas prior to Gas Separation in the Haber-Bosch Process, 2) Compress N₂ and H₂ gasses prior to entry into the Ammonia Reactor, and/or 3) Compress recycled N₂ and H₂ prior to re-entry into the Ammonia Reactor. Pressure created/captured from the system is useful when creating ethanol to compress gas fed into the fermentation reactor.

High temperatures created/captured from the system are useful when creating ammonia to 1) Heat N₂ and H₂ following Gas Separation in the Haber-Bosch process and/or 2) to convert CO into CO₂ in a water-gas shift process prior to Gas Separation in the Haber-Bosch process. High temperatures created/captured from the system are useful when creating electricity to heat water for a steam turbine.

Low temperatures created/captured from the system are useful when creating ammonia to condense NH₃, N₂, and H₂ coming out of the heat exchanger attached to the ammonia reactor. Low temperatures created/captured from the system are useful when creating electricity to condense the cool side of Rankine cycle for steam turbine electrical generation.

Electrical energy created/captured from the system is useful when creating ammonia for 1) LPST refrigeration, 2) heaters for any high temperature operation, 3) compressors for any high pressure operation, 4) refrigeration for any low temperature operation, and/or 5) pumps for any fluid movement operation. Electrical energy created/captured from the system is useful when creating ethanol for 1) heaters for any high temperature operation, 2) compressors for any high pressure operation, 3) refrigeration for any low temperature operation, and/or 4) pumps for any fluid movement operation. Electrical energy created/captured from the system is useful in agricultural applications to pump water. Electrical energy created/captured from the system is also useful as a market product.

Ammonia created/captured from the system is useful when creating ethanol is useful for 1) combustion for heat for high-temperature reactions, 2) storing hydrogen. Ammonia created/captured from the system is useful when creating electricity for combustion for heat for high-temperature reactions. Ammonia created/captured from the system are useful in agricultural applications for 1) combustion for transportation and/or 2) as fertilizer. Ammonia created/captured from the system is also useful as a market product.

Ethanol created/captured from the system is useful when creating electricity to help condense steam in a turbine for the Rankine cycle. Ethanol created/captured from the system is also useful as a market product. Ethanol created/captured from the system is useful in agricultural applications for transportation. Ethanol created/captured from the system is also useful for reaction promotion for burning ammonia in an internal combustion engine.

### SEQUENCE LISTING

Not Applicable

1. A poly-generation method of creating ammonia comprising:
A) extracting water from a high-temperature exhaust source,
B) generating electricity from thermal energy in a high-temperature exhaust source,
I) using generated electricity to separate hydrogen from water extracted from a high-temperature exhaust source,
II) using generated electricity to extract nitrogen from air,
III) using generated electricity to pressurize a reaction chamber where ammonia is created using the Haber Bosch process,
C) extracting heat from a high-temperature exhaust source, and
I) using extracted heat to heat a reaction chamber where ammonia is created using the Haber Bosch process.

2. The method of claim 1 further comprising:
A) feeding exhaust gasses into a biological process which produces ethanol from carbon dioxide.

3. The method of claim 2 further comprising:
A) using heat extracted from the high-temperature exhaust source to maintain the temperature for the ethanol producing biological process.

4. A poly-generation apparatus comprising:
A) a high-temperature exhaust source,
B) a means for generating electricity from the high-temperature exhaust source,
C) an ammonia reaction chamber configured to generate ammonia at high temperature and pressure, and
D) a means for transferring heat from the high-temperature exhaust source to the ammonia reaction chamber.

5. The poly-generation apparatus of claim 4 further comprising:
A) means for extracting water from a high-temperature exhaust source.

6. The poly-generation apparatus of claim 5 further comprising:
A) means for extracting hydrogen for the ammonia reaction chamber, at least in part, from water extracted from the high-temperature exhaust source.

7. The poly-generation apparatus of claim 6 further comprising:
A) means for extracting nitrogen for the ammonia reaction chamber from air using, at least in part, electricity generated from the high-temperature exhaust source.

8. The poly-generation apparatus of claim 7 further comprising:
A) means for creating ethanol from exhaust gasses.
